(19) United States
(12) Patent Application Publication
(10) Pub. No.: US 2024/0171113 A1
(43) Pub. Date: May 23, 2024

(54) MULTI-FUNCTIONAL POWER SUPPLY/GENERATOR EXPANSION SYSTEMS, METHODS, AND DEVICES

(71) Applicant: 4Patriots, LLC, Nashville, TN (US)

(72) Inventors: Matt JOHNSON, Nashville, TN (US); Emily D. EVANS, Nashville, TN (US); Ben RENEER, Provo, UT (US); Bryce TWEDE, Provo, UT (US); Michael HORITO, Provo, UT (US); Tyler ALLAN, Provo, UT (US)

(73) Assignee: 4Patriots, LLC, Nashville, TN (US)

(21) Appl. No.: 17/993,132

(22) Filed: Nov. 23, 2022

Related U.S. Application Data
(63) Continuation-in-part of application No. 29/860,795, filed on Nov. 22, 2022.

(51) Int. Cl. H02S 10/40; H02S 10/20; H02S 40/32; H02S 40/34; H02S 40/38

(52) U.S. Cl. CPC H02S 10/40; H02S 10/20; H02S 40/32; H02S 40/34; H02S 40/38

(57) ABSTRACT

Multi-functional power distribution unit transitionable between different configurations and form factors to perform various power storage and distribution functions. Conversion cap attaches to a top of an expansion battery to convert the expansion battery into the multi-functional power distribution unit. A three-point coupling arrangement safely connects two power connectors (such as spring-loaded) of the expansion cap to two terminals on the expansion battery. Slidable/rotatable handles provide a gripping area for carrying the device yet remain unobstructive when stored. The multi-functional power distribution unit expands a power capacity of a power supply and/or generator (e.g., a solar-based power generator) and/or charges the expansion battery in a first configuration with the expansion cap connected to the power generator. Upon disconnecting from the power generator, the multi-functional power distribution unit transitions to a second configuration providing a standalone power supply (e.g., a 120 V AC power supply).

### CROSS REFERENCE TO RELATED APPLICATION

This application is a continuation in part of U.S. Design application Ser. No. 29/860,795, filed Nov. 22, 2022, the contents of which is hereby incorporated by reference in its entirety.

### FIELD

The present disclosure generally relates to systems, methods, and devices for distributing power.

### BACKGROUND

Power supplies/generators typically have a maximum storage and output capacity. In some situations, the storage and output capacity can be expanded by incorporating larger sized battery units. However, such an approach can result in power supplies/generators that are heavy, bulky, and expensive to ship or carry, which can outweigh the benefits the larger unit is meant to provide.

### BRIEF DESCRIPTION OF THE DRAWINGS

The foregoing summary, as well as the following detailed description, will be better understood when read in conjunction with the appended drawings. For the purpose of illustration, there is shown in the drawings certain examples of the disclosed subject matter. It should be understood, however, that the disclosed subject matter is not limited to the precise examples and features shown. The accompanying drawings, which are incorporated in and constitute a part of this specification, illustrate implementations of systems, methods, and devices consistent with the disclosed subject matter and, together with the description, serves to explain advantages and principles consistent with the disclosed subject matter, in which:

FIG. 1 illustrates an example system for power distribution having a power generator and a multi-functional power distribution unit formed by an expansion battery and a conversion cap;

FIG. 2 illustrates an example system for power distribution including a multi-functional power distribution unit formed with a three-point coupling arrangement between a conversion cap and an expansion battery, which can form at least a portion of the system depicted in FIG. 1;

FIG. 3 illustrates an example system for power distribution including a multi-functional power distribution unit to expand an output capacity of a solar-based power generator and/or provide a standalone power supply, which can form at least a portion of the system depicted in FIG. 1;

FIG. 4 illustrates an example block diagram of a system for power distribution having a power generator, an expansion battery, and a conversion cap; and

FIG. 5 illustrates an example method for distributing power with a multi-functional power distribution unit, which can be performed by the system depicted in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the examples described herein. The drawings are not necessarily to scale and the proportions of certain parts may be exaggerated to better illustrate details and features of the present disclosure.

The phraseology and terminology employed herein are for the purpose of description and should not be regarded as limiting. For example, the use of a singular term, such as, “a” is not intended as limiting of the number of items. Also, the use of relational terms such as, but not limited to, “top,” “bottom,” “left,” “right,” “upper,” “lower,” “down,” “up,” and “side,” are used in the description for clarity in specific reference to the figures and are not intended to limit the scope of the presently disclosed technology or the appended claims. Further, it should be understood that any one of the features of the presently disclosed technology may be used separately or in combination with other features. Other systems, methods, features, and advantages of the presently disclosed technology will be, or become, apparent to one with skill in the art upon examination of the figures and the detailed description. It is intended that all such additional systems, methods, features, and advantages be included within this description, be within the scope of the presently disclosed technology, and be protected by the accompanying claims.

Further, as the presently disclosed technology is susceptible to examples of many different forms, it is intended that the present disclosure be considered as an example of the principles of the presently disclosed technology and not intended to limit the presently disclosed technology to the specific examples shown and described. Any one of the features of the presently disclosed technology may be used separately or in combination with any other feature. References to the terms “example,” “examples,” and/or the like in the description mean that the feature and/or features being referred to are included in, at least, one aspect of the description. Separate references to the terms “example,” “examples,” and/or the like in the description do not necessarily refer to the same example and are also not mutually exclusive unless so stated and/or except as will be readily apparent to those skilled in the art from the description. For example, a feature, structure, process, step, action, or the like described in one example may also be included in other examples, but is not necessarily included. Thus, the presently disclosed technology may include a variety of combinations and/or integrations of the examples described herein. Additionally, all aspects of the present disclosure, as described herein, are not essential for its practice. Likewise, other systems, methods, features, and advantages of the presently disclosed technology will be, or become, apparent to one with skill in the art upon examination of the figures and the description. It is intended that all such additional systems, methods, features, and advantages be included within this description, be within the scope of the presently disclosed technology, and be encompassed by the claims.

Any term of degree such as, but not limited to, “substantially,” as used in the description and the appended claims, should be understood to include an exact, or a similar, but not exact configuration. For example, “a substantially planar surface” means having an exact planar surface or a similar, but not exact planar surface. Similarly, the terms “about” or “approximately,” as used in the description and the appended claims, should be understood to include the recited values or a value that is three times greater or one third of the recited values.

The term “coupled” is defined as connected, whether directly or indirectly through intervening components, and is not necessarily limited to physical connections. The connection can be such that the objects are permanently connected or releasably connected. The terms “comprising,” “including” and “having” are used interchangeably in this disclosure. The terms “comprising,” “including” and “having” mean to include, but not necessarily be limited to the things so described.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

Systems, methods, and devices disclosed herein can address the aforementioned issues by providing a multi-functional power distribution unit to perform multiple functions in different configurations. For instance, a conversion cap can attach to the top of an expansion battery to form the multi-functional power distribution unit. In a first configuration, the multi-functional power distribution unit can electrically connect to a power generator to expand an output capacity of the power generator (such as a full load continuous maximum output as measured in kW, an output duration, or combinations thereof). The multi-functional power distribution unit can effectively double the output capacity and period of usage of the power generator by connecting the expansion battery to the solar-powered based generator. In the second configuration, the multi-functional power distribution unit can operate as a standalone power supply. The conversion cap can draw a DC voltage from the expansion battery, and can convert that DC voltage into an AC voltage (e.g., 120 V AC) accessible via two-prong or three-prong outlets on a front face of the expansion cap.

The configuration and/or form factor(s) of the multi-functional power distribution unit can satisfy shipping requirements and reduce shipping costs by conforming to a form factor/footprint of a 12 volt lithium battery. Moreover, the form factor(s) disclosed herein can be easy to carry and/or integrate into RVs, golf carts, boats, a roller system, a wall mount, and so forth. The capability to transition between different functions, shapes, and power capacities provides greater flexibility for using the power distribution system in different scenarios, such as camping, hiking, power outages, road trips, RV traveling, power storage (such as whether ordinary or emergency), mobile or remote power supply, permanent or semi-permanent power supply, and so forth.

Furthermore, safety of the devices disclosed herein can be improved by using an arrangement of slidable, spring-loaded screws that only expose the conducting portion of the screw when the conversion cap is pressed against the expansion battery, forming a closed environment. Reducing exposure to these conductive connector components can prevent unintended electrocution. Additionally, insulated knobs to twist the screws on the conversion cap can further prevent unintended electrical discharges from accidental short circuits.

Additional benefits and advantages of the disclosed technology will become apparent from the detailed description below.

For instance, the aforementioned problems can be addressed using the systems, methods, and devices disclosed herein. In some instances, a power distribution system can include a conversion cap which removably couples to a top surface of an expansion battery to form a multi-functional power distribution unit transitionable between a first configuration and a second configuration. The first configuration can be a configuration in which the multi-functional power distribution unit is removably coupled to a solar-based power generator to: expand an output capacity of the solar-based power generator; and/or charge the expansion battery. The second configuration can be a configuration in which the multi-functional power distribution unit is separate from the solar-based power generator and operates as a standalone alternating current power supply.

In some examples, the top surface of the expansion battery includes a first terminal, a second terminal, and/or an indent. Additionally, the conversion cap can include a first spring-loaded power connector extending from below a first corner of the conversion cap for coupling to the first terminal; a second spring-loaded power connector extending from below a second corner of the conversion cap for coupling to the second terminal; and/or a connector protrusion for hooking into the indent. the top surface of the expansion battery can be raised above an outer shelf disposed around a perimeter of the expansion battery. The expansion battery can further include one or more handles slidable into a space between the outer shelf and the top surface of the expansion battery. Moreover, the one or more handles can be rotatable, from the space between the outer shelf and the top surface of the expansion battery, over a central elevated top surface; and/or one or more gripping gaps can be formed between the one or more handles and one or more lower tier surfaces adjacent to the central elevated top surface. In some instances, the expansion battery includes a 12 volt lithium battery. Additionally or alternatively, the multi-functional power distribution unit can form a portable standalone alternating current power supply in the second configuration, and the solar-based power generator can be a portable power generator.

In some scenarios, a power distribution system includes an expansion battery with a top surface including a first terminal and a second terminal; and/or a conversion cap which removably couples to the expansion battery to form a multi-functional power distribution unit transitionable between: a first configuration expanding an output capacity of a solar-based power generator; and/or a second configuration as a standalone alternating current power supply. The conversion cap can have a footprint corresponding to the top surface of the expansion battery such that a conversion cap perimeter is within an expansion battery perimeter when the conversion cap is coupled to the expansion battery. The conversion cap can also include: a charger to communicatively couple to the expansion battery for providing input voltage, received from the solar-based power generator, to the expansion battery; a regulator for regulating output voltages of the conversion cap; one or more power outlets on a front face of the conversion cap; and/or a power inverter to provide the standalone alternating current power supply through the one or more power outlets. By way of examples, the input voltage can be received form the solar-based power generator through a power cord of the conversion cap that plugs into the solar-based power generator. Moreover, the one or more power outlets can be within an expansion battery perimeter when the multi-functional power distribution unit is in the second configuration. Additionally, the conversion cap can include a controller which: receives an indication that the multi-functional power distribution unit is in the first configuration; and/or actuates, in response to the indication that the multi-functional power distribution unit is in the first configuration, a cut-off switch causing power access to be restricted from the one or more power outlets.

In some examples, the conversion cap includes a light indicator; and the controller, in response to actuating the cut-off switch, activates the light indicator to visually represent the power access being restricted from the one or more power outlets. The conversion cap can also include a digital communicator to send a communication to a controller of the solar-based power generator, in response to the multi-functional power distribution unit transitioning to the first configuration. Furthermore, the solar-based power generator can perform an operation in response to receiving the communication from the conversion cap. In some instances, the conversion cap uses a three-point coupling arrangement to removably couple to a top surface of the expansion battery. The three-point coupling arrangement can include a first spring-loaded power connector extending from below a first corner of the conversion cap for coupling to the first terminal of the expansion battery; a second spring-loaded power connector extending from below a second corner of the conversion cap for coupling to the second terminal of the expansion battery; and/or a connector protrusion for hooking into a corresponding indent in a top surface of the expansion battery. Additionally or alternatively, the multi-functional power distribution unit includes one or more power cord, and is chargeable in one or more configurations, such as in the first configuration by receiving power through the one or more power cord connected to the solar-based power generator while simultaneously expanding the output capacity of the solar-based power generator; and/or in a third configuration by receiving power through the one or more power cord connected to an alternating current wall outlet.

In some instances, a method of generating solar-based power includes forming a multi-functional power distribution unit by coupling a conversion cap to an expansion battery at a first terminal of the expansion battery and at a second terminal of the expansion battery; expanding an output capacity of a solar-based power generator by a removable coupling of the multi-functional power distribution unit to the solar-based power generator that puts the multi-functional power distribution unit into a first configuration; increasing a charge of the expansion battery while the multi-functional power distribution unit is in the first configuration; transitioning the multi-functional power distribution unit between the first configuration and a second configuration using the removable coupling of the multi-functional power distribution unit to the solar-based power generator; and providing, with the multi-functional power distribution unit, a standalone alternating current power supply while the multi-functional power distribution unit is in the second configuration. The method can further comprise, for instance, in response to transitioning the multi-functional power distribution unit from the first configuration to a second configuration, actuating a switch in the multi-functional power distribution unit to provide power from the expansion battery, through an inverter, to one or more outlets disposed on the conversion cap.

The foregoing summary is intended to be illustrative and is not meant in a limiting sense. Many features of the examples may be employed with or without reference to other features of any of the examples. Additional aspects, advantages, and/or utilities of the presently disclosed technology will be set forth in part in the description that follows and, in part, will be apparent from the description, or may be learned by practice of the presently disclosed technology.

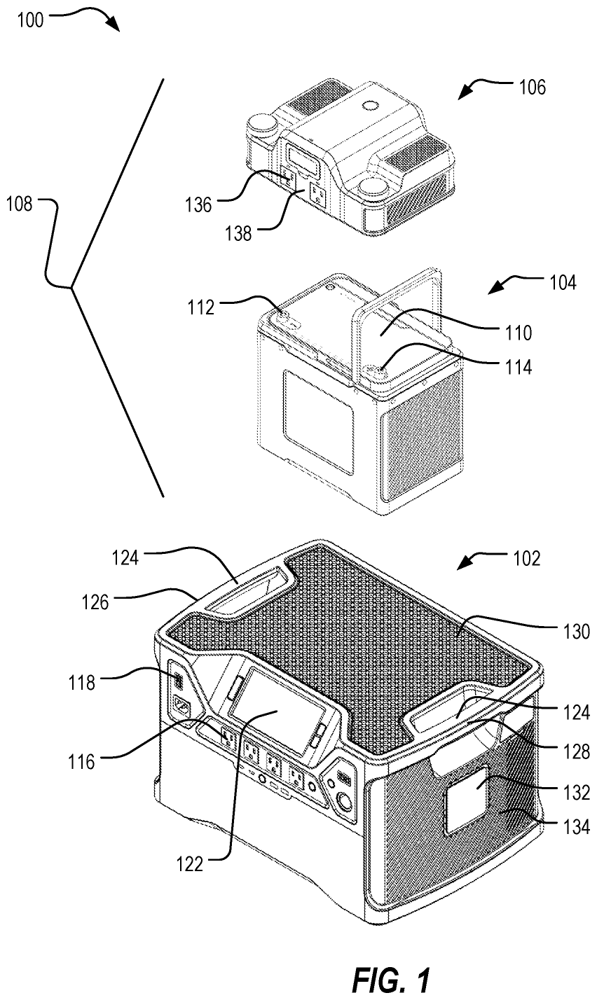

FIG. 1 illustrates an example system 100 including a power generator 102 (such as a solar-based power generator), an expansion battery 104, and/or a conversion cap 106. The conversion cap 106 can removably couple to the expansion battery 104. A multi-functional power distribution unit 108 is formed when the conversion cap 106 is coupled to the expansion battery 104. For example, the expansion battery 104 can be coupled, using a three-point coupling arrangement, to the conversion cap 106. The conversion cap 106 can mate to a top surface 110 of the expansion battery 104 by coupling to a first terminal 112 and a second terminal 114 of the expansion battery 104. Moreover, the expansion battery 104 can be transitionable between a first configuration with the multi-functional power distribution unit 108 removably coupled to the power generator 102, and a second configuration with the multi-functional power distribution unit 108 separated from the power generator 102. In the first configuration, the multi-functional power distribution unit 108 can expand or increase an output capacity of the power generator 102. Additionally, in the second configuration, the multi-functional power distribution unit 108 can be a standalone alternating current (AC) power supply. Additionally or alternatively, the multi-functional power distribution unit 108 can be transitioned to a third configuration by separating the conversion cap 106 (and, in some instances, the power generator 102) from the expansion battery 104. In the third configuration, the expansion battery 104 can provide a direct current (DC) power supply via the first terminal 112 and the second terminal 114.

In some examples, the power generator 102 can be a solar-based power generator that receives an input voltage from a solar power and converts the input voltage to an output alternating current voltage, accessible via one or more generator outlets 116 (such as standard 120 volt two or three prong outlets). The power generator 102 can have a first output capacity when the multi-functional power distribution unit 108 is in the second configuration, disconnected from the power generator 102. The first output capacity of the power generator 102 can be between 1000 watt-hours (Wh) and 1600 Wh (such as 1500 Wh, 1510 Wh, 1520 Wh, 1530 Wh, 1540 Wh, 1550 Wh, and so forth). Additionally the power generator 102 can have a solar input capacity of between 300 W and 800 W (such as 500 W, 525 W, 550 W, 575 W, 600 W, and so forth). The power generator 102 can include various components for connecting with other devices and performing the operations discussed herein. For instance, the power generator 102 can include one or more USB ports 118 for connecting to a user device (such as a mobile device) for charging and/or data transfer with the user device. Moreover, the power generator 102 can include a display 122 presenting a graphical user interface (GUI) for receiving user inputs and/or presenting outputs or other information of the power generator 102.

Additionally, the power generator 102 can have multiple form factor components that improve operation of the system 100. One or more ports (such as the one or more generator outlets 116, the one or more USB ports 118, and so forth) can be tilted forward to prevent water egress and/or can be flush with a front surface (and can also be tilted) to provide space for receiving larger connectors (such as “wall warts”). The display 122 can be tilted or angled upwards to improve the visibility of the display 122 when the power generator 102 is resting at ground level. One or more side handles 124 formed into a first side edge 126 and/or a second side edge 128 can have an ergonomic shape and thickness. The power generator 102 can include a recess formed onto a top tray 130 for receiving the bottom of the expansion battery 104 and/or preventing lateral movement of the multi-functional power distribution unit 108 when the multi-functional power distribution unit 108 and the power generator 102 are in the first configuration. The top tray 130 can include a gripping texture, such as a rubber material, raised stripes, dimples, a crosshatch pattern, a star pattern, or the like, to further prevent movement of the multi-functional power distribution unit 108 when the multi-functional power distribution unit 108 is placed on the power generator 102. The power generator 102 can also include a cable storage compartment (such as formed into a rear side of the power generator 102) for storing power cables during transportation of the power generator 102. Moreover, the power generator 102 can include an expansion port 132, which can be formed into a side 134 of the power generator 102. The expansion port 132 can have a cover (such as a rubber flap) to prevent water/debris ingress and tampering. The expansion port 132 can be used to transition the power generator 102 and the multi-functional power distribution unit 108 between the first configuration and the second configuration. For instance, a cable extending from the conversion cap 106 can be plugged into and/or removed from the expansion port 132 for the transition to create and/or decouple a power connection and/or a data connection, as discussed in greater detail below.

In some examples, the multi-functional power distribution unit 108 can include multiple expansion port 132, such as a first expansion port 132 on a first side of the multi-functional power distribution unit 108 and/or a second expansion port expansion port 132 on a second side of the multi-functional power distribution unit 108. In some scenarios, the multi-functional power distribution unit 108 can be a first multi-functional power distribution 108 which can be couplable to one or more additional multi-functional power distributions in a “daisy-chained” configuration. In the daisy-chained configuration, the expansion port(s) 132 can be used to connect a plurality of multi-functional power distribution unit(s) 108 together, in series, to further increase the expanded output capacity an amount proportional to the number of multi-functional power distribution unit(s) 108 connected together. Moreover, the daisy-chained configuration can provide the standalone AC power supply having an expanded output duration.

In some instances, the conversion cap 106 integrates multiple components for performing the operations discussed herein. For instance, the conversion cap 106 can include one or more power outlets 136 on a front face 138 of the conversion cap 106. Additionally, the conversion cap 106 can house an inverter (such as a 500 W inverter) coupled to the one or more power outlets 136. Accordingly, the one or more power outlets 136 can provide AC power (such as 120 V AC power) to a device plugged into the one or more power outlets 136 when the multi-functional power distribution unit 108 is in the second configuration. In this way, the multi-functional power distribution unit 108 can act as a standalone AC power supply when in the second configuration by using the one or more power outlets 136. Moreover, the conversion cap 106 can house a charger communicatively couplable to the expansion battery 104 (such as at the first terminal 112 and the second terminal 114) to provide a charging input voltage, received from the power generator 102 when in the first configuration, to the expansion battery 104.

In some instances, the standalone status of the multi-functional power distribution unit 108 is based on the multi-functional power distribution unit 108 providing power while omitting a power connection to the power generator 102 and/or omitting another power connection (such as to an A/C wall outlet, to another multi-functional power distribution unit 108, to another expansion battery 104, and so forth), which the multi-functional power distribution unit 108 may otherwise use while charging or providing capacity expansion. In some scenarios, the multi-functional power distribution unit 108 can transition between the standalone status and a charging status, such as a charging status in the first configuration using one or more power plugs to removably couple to the power generator 102, and/or a charging status of a third configuration using one or more power plugs to removably couple to an A/C wall outlet. Additionally or alternatively, the power generator 102 can plug into the A/C wall outlet to receive power for a microcontroller and/or to replace or augment power provided to the power generator by other sources, such as solar panels, diesel, gas, hydro, geothermal, and so forth.

In some instances, components of the system 100 can be portable components. For instance, the multi-functional power distribution unit 108 can form a portable unit carriable or liftable by an individual person, having human-carriable weight (such as less than 30 lbs., 40 lbs., 50 lbs., 60 lbs., 70 lbs., 80 lbs., 90 lbs., 100 lbs., or so forth), and/or a human-carriable profile (such as less than three or four feet in a width and/or length dimension). The portable status of the multi-functional power distribution unit 108 can be based on the multi-functional power distribution unit 108 being detachable from positionally fixed components (such as a wall outlet, a ground connector, etc.) such that the multi-functional power distribution unit 108 can be carried from a first location (such as a first usage location and/or a first storage location) to a second location (such as a second usage location and/or a second storage location), and/or while performing functions of the second configuration at the first location, during transition between the first location, and/or at the second location. The multi-functional power distribution unit 108 can omit attachment mechanisms for permanently or fixedly attaching to other components or being permanently or semi-permanently installed at a wall, a building, a floor, etc. The multi-functional power distribution unit 108 can be portable by using hand-actuated removable coupling mechanism (such as plugs and/or threaded components) to transition between different configurations (such as multiple times). When the multi-functional power distribution unit 108 is detached from other components and/or has the coupling mechanism detached (such as with power cords wrapped around spools and/or stowed), the multi-functional power distribution unit 108 can be a portable unit. The multi-functional power distribution unit 108 may be portable because it can be grabbed, lifted, and/or relocated (such as for use at multiple locations rather than a single building or a single installed location) by one or two people while omitting usage of installation tools. Additionally or alternatively, the power generator 102 and/or the expansion battery 104 can be a portable unit or have the portable status by having any of the portable characteristics described above. For instance, the power generator 102 can be a portable power generator, carriable between multiple locations by one or two people (such as using one or more handles), and/or can omit permanent or static coupling mechanisms.

In some examples, the expansion battery 104 is a 12 V battery and/or a lithium iron phosphate battery. The expansion battery 104 can have a 1344 Wh capacity. The expansion battery 104 can be transitioned into a 500 W/1400 Wh standalone power source for the multi-functional power distribution unit 108 in the second configuration.

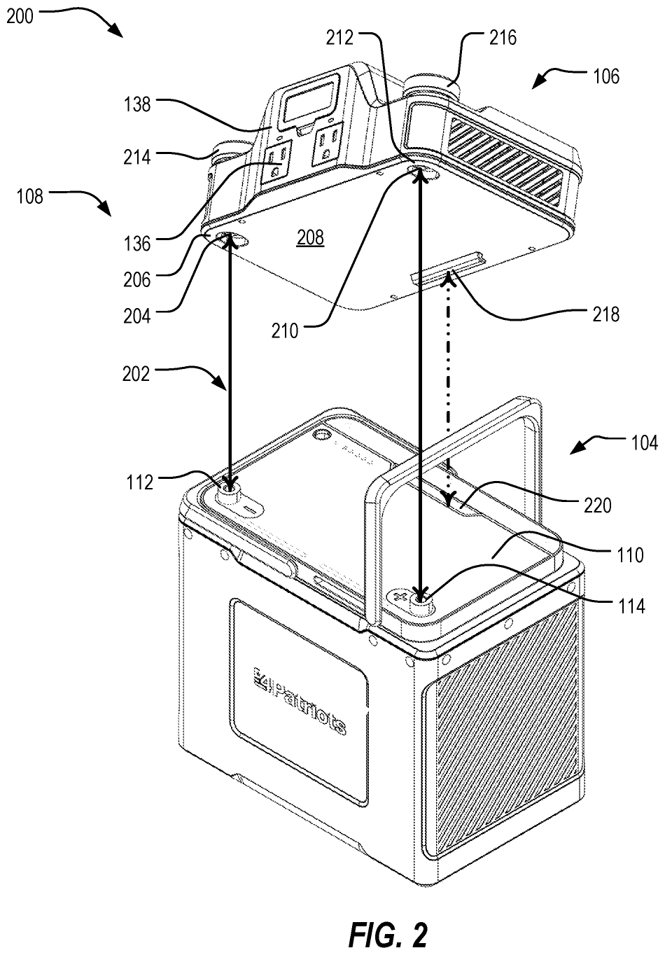

FIG. 2 illustrates an example system 200 including the conversion cap 106 and the expansion battery 104, which can form at least a portion of the system 100 of FIG. 1. FIG. 2 shows these components of the multi-functional power distribution unit 108 in a separated configuration for explanation purposes.

In some examples, the system 200 uses a three-point coupling arrangement 202 to removably couple to the expansion battery 104. The conversion cap 106 can have two front power attachments for mating with the first terminal 112 and the second terminal 114 on the expansion battery 104. For instance, the conversion cap 106 can include a first spring-loaded screw 204 extending from a first corner 206 at a bottom surface 208 of the of the conversion cap 106 which mates with the first terminal 112; and a second spring-loaded screw 210 extending from a second corner 212 to mate with the second terminal 114. A first knob 214 can extend above a top surface of the conversion cap 106 with the first spring-loaded screw 204 passing through a body of the conversion cap 106 to couple to the first knob 214. Likewise, a second knob 216 can extend from the top surface of the conversion cap 106 with the second spring-loaded screw 210 passing through the body of the conversion cap 106 to couple the second spring-loaded screw 210 to the second knob 216. The first knob 214 and/or the second knob 216 can be insulated and/or include a circular knob shaped to fit in palm of a hand (such as having a diameter in a range of 1-6 inches). The first knob 214 and the second knob 216 may be used to screw, unscrew, push, and/or pull the first spring-loaded screw 204 and the second spring-loaded screw 210, respectively. Accordingly, the first spring-loaded screw 204 and/or the second spring-loaded screw 210 can extend past a plane defined by the bottom surface 208 (such as to connect to the expansion battery 104) and/or be retracted into the conversion cap 106 with terminating ends of the first spring-loaded screw 204 and the second spring-loaded screw 210 not extending past the plane defined by the bottom surface 208 when the conversion cap 106 (such as improving safety when disconnected from the expansion battery 104). The first spring-loaded screw 204 and/or the second spring-loaded screw 210 can be formed of conductive material that conducts electricity to the first terminal 112 and the second terminal 114. As such the first spring-loaded screw 204 and/or the second spring-loaded screw 210 can form a conductive pathway to provide a charging voltage to the expansion battery 104, (such as while receiving power from the power generator 102 in the first configuration and/or while receiving power from a 120 V AC cord plugged into another 120 AC volt power source). Additionally, the conductive path can be used to draw power from the expansion battery 104 into the conversion cap 106 in the second configuration.

Furthermore, the three-point coupling arrangement 202 can include a connector protrusion 218 extending from the bottom surface 208 of the conversion cap 106. The connector protrusion 218 can have a curve facing towards a rear portion of the expansion battery 104 (such as concavely) and/or the connector protrusion 218 can be aligned near a rear edge (within between 0.1 and 6 inches) or at a rear half of the bottom surface 208, and can be centrally spaced between the first spring-loaded screw 204 and the second spring-loaded screw 210. The connector protrusion 218 can extend a length with a linear body. The first spring-loaded screw 204, the second spring-loaded screw 210, and the connector protrusion 218 can form an isometric or equilateral triangle on the bottom surface 208. The connector protrusion 218 can be configured to mate with a corresponding cut-out, groove, or indent 220 on the top surface 110 of the expansion battery 104. The connector protrusion 218 can form the three-point coupling arrangement 202 together with the first spring-loaded screw 204 and the second spring-loaded screw 210, which can securely fasten the conversion cap 106 to the expansion battery 104 with accurate and safe coupling to the battery terminals in a quick and intuitive manner.

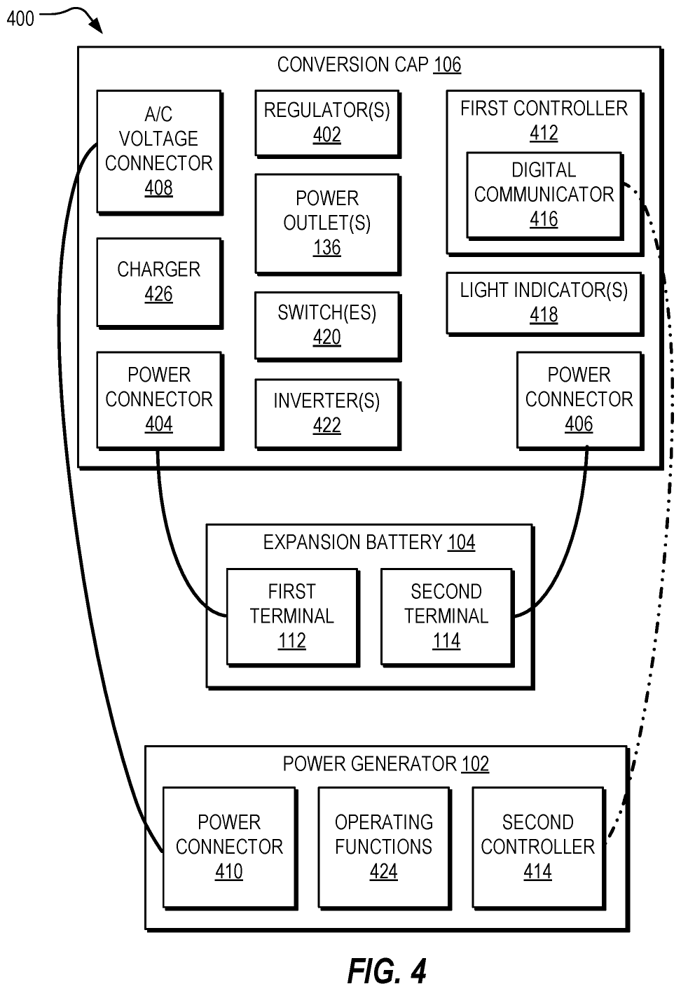

In some instances, a user places the connector protrusion 218 into the expansion battery 104 and slides the conversion cap 106 back into place on the expansion battery 104. The first spring-loaded screw 204 and the second spring-loaded screw 210 can initially be held in an open position with the screw retracted by the spring tension. With the connector protrusion 218 hooked, the user can push down on the first spring-loaded screw 204 and/or the second spring-loaded screw 210 until the first spring-loaded screw 204 and the second spring-loaded screw 210 contact the first terminal 112 and the second terminal 114. At this point, the user can begin rotating the first spring-loaded screw 204 and/or the second spring-loaded screw 210 until their threading(s) catch on the first terminal 112 and/or the second terminal 114, securing the conversion cap 106 to the expansion battery 104. Additionally, should the expansion battery 104 need replacing, the first spring-loaded screw 204 and the second spring-loaded screw 210 can be unscrewed and the connector protrusion 218 unhooked from the indent 220. Moreover, as discussed in greater detail below regarding FIG. 4, the connector protrusion 218 and/or other components protruding from the bottom surface 208 can form one or more data connections with a controller in the expansion battery 104 (such as for performing control functions on the battery, for receiving a charge reading from the battery, and the like.). For instance, the indent 220 can include a data connector; and/or the first terminal 112 and/or the second terminal 114 can include spring-loaded connectors or other data connector(s) for making a data connection between the conversion cap 106 and the controller of the expansion battery 104. In some examples, the expansion battery 104 and the conversion cap 106 can be manufactured as a single integrated unit and/or can be permanently fixed together to form the multi-functional power distribution unit 108.

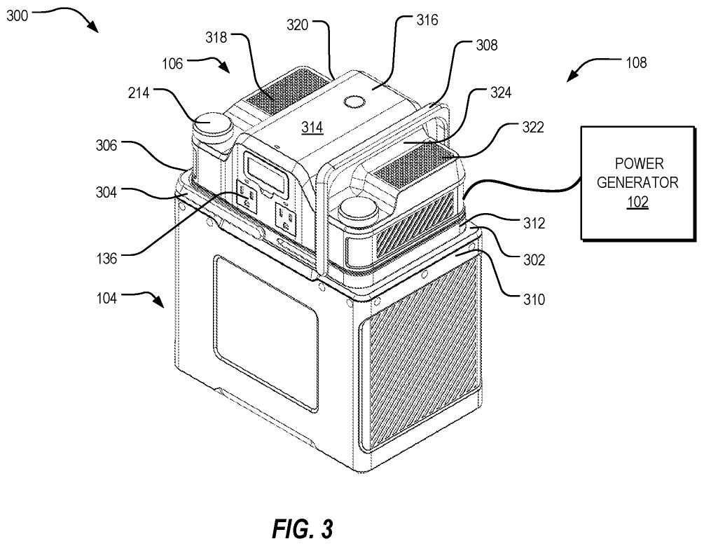

In some instances, the conversion cap 106 has a form factor that corresponds to a form factor of the expansion battery 104. For instance, at its top surface 110, the expansion battery 104 can have a substantially rectangular footprint or top profile (such as a shape from a top view), with rounded corners, which can define a perimeter of the expansion battery 104. The conversion cap 106 can also have a substantially rectangular footprint or top profile, which corresponds to the perimeter of the expansion battery 104 such that a conversion cap perimeter is within an expansion battery perimeter when the conversion cap 106 is coupled to the expansion battery 104. As such, the one or more power outlets 136 on the front face 138 of the conversion cap 106 can also be within the expansion battery perimeter when the conversion cap 106 is coupled to the expansion battery 104. These form factor features can make the multi-functional power distribution unit 108 easy to carry and store for transport. The form factor, along with a 10-30 lbs. (such as 20 lbs.) weight of the multi-functional power distribution unit 108, can additionally reduce shipping costs. Moreover, the form factor features of the multi-functional power distribution unit 108 can provide space for slidable handles to extend from the expansion battery 104 and over the conversion cap 106, as discussed below regarding FIG. 3.

FIG. 3 illustrates an example system 300 including the multi-functional power distribution unit 108 with the conversion cap 106 attached to the expansion battery 104. The system 300 can form at least a portion of the system 100 of FIG. 1. FIG. 3 depicts the multi-functional power distribution unit 108 connected to the power generator 102 and, accordingly, being in the first configuration.

In some examples, the top surface 110 of the expansion battery 104 is raised above an outer shelf 302 disposed around the perimeter of the expansion battery 104. For instance, the outer shelf 302 can have a perimeter greater than the perimeter of the raised top surface 110 and/or a perimeter of the conversion cap 106 (such as which can be flush with the raised top surface 110). One or more handles may fit or rest on a flat surface defined of the outer shelf 302, for instance, when the handle(s) are in a stored state. The one or more handles can include a first slidable handle 304 positioned at a planar surface defined by the outer shelf 302 around a first side 306 of the expansion battery 104. A second slidable handle 308 can be positioned at the planar surface around a second side 310 of the expansion battery 104. The first slidable handle 304 and the second slidable handle 308 can couple into an upright inner wall 312 defining the inner perimeter of the raised top surface 110. In some scenarios, terminating ends of the first slidable handle 304 and the second slidable handle 308 couple to slide channels formed into the upright inner wall 312. A first front slide channel can receive a first end of the first slidable handle 304 and a first rear slide channel can receive a second end of the first slidable handle 304 and. Similarly, a second front slide channel can receive a first end of the second slidable handle 308 and a second rear front slide channel can receive a second end of the second slidable handle 308. The first slidable handle 304 and/or the second slidable handle 308 can slide a length of the slide channels to be pulled away from the expansion battery 104 in a horizontal direction. Furthermore, the ends of the first slidable handle 304 and the second slidable handle 308 can be rotatable while being secured in the slide channels. As such, the first slidable handle 304 and the second slidable handle 308 can be slid out of the outer shelf 302 and rotated towards each other in a way that creates a gripping space around the first slidable handle 304 and the second slidable handle 308 when they are moved into this unstored position.

Furthermore, the conversion cap 106 can have one or more form factor feature(s) to create the gripping space between the first slidable handle 304 and a top surface 314 of the conversion cap 106. A central elevated top surface 316 can extend from the front face 138 of the conversion cap 106 to a rear face of the conversion cap 106. A first height of the conversion cap 106 from the bottom surface 208 to the central elevated top surface 316 can be less than a gap distance of the first slidable handle 304 and/or the second side 310 when the first slidable handle 304 and the second side 310 are in an upright gripping position. Moreover, the expansion battery 104 can include a first lower tier surface 318 adjacent to a first side 320 of the central elevated top surface 316; and a second lower tier surface 322 adjacent to a second side 324 of the central elevated top surface 316. The expansion battery 104 can have a second height from the bottom surface 208 to the second lower tier surface 322 and/or the second height can be less than the first height at the central elevated top surface 316. To unstore and/or use the first slidable handle 304 and the second side 310, they can be rotated over the central elevated top surface 316 and/or the second lower tier surface 322 and the second side 324. A first gripping gap can be formed between the first lower tier surface 318 and the first slidable handle 304 and a second gripping gap can be formed between the second lower tier surface 322 and the second side 310.

FIG. 4 illustrates a block diagram of an example system 400 including components of the multi-functional power distribution unit 108 and the power generator 102. FIG. 4 depicts operations which can transition the multi-functional power distribution unit 108 and the power generator 102 between the first configuration and the second configuration. The system 400 can form at least a portion of the system 100 depicted in FIG. 1.

In some examples, the conversion cap 106 includes various components for performing output capacity expansion operations in the first configuration, power supply operations in the second configuration, and transitioning between the configurations. For instance, the expansion battery 104 can include the power outlet(s) 136 for providing the output AC voltage supply, and/or one or more regulator(s) 402 to maintain or regulate constant output voltage(s) for the various voltages discussed herein. The conversion cap 106 can also include a first power connector 404 (such as the first spring-loaded screw 204) to couple to the first terminal 112 and/or a second power connector 406 to couple to the second terminal 114. Moreover, to connect to the power generator 102, the conversion cap 106 can include an A/C voltage connector 408 (such as a two-prong plug or a three-prong plug) which attaches, removably couples, and/or plugs into a power connector 410 at the power generator 102. The second side 310 can output a voltage power (such as generated by a solar panel) to the conversion cap 106.

In some instances, the conversion cap 106 includes a first controller 412, including one or more processors for communicating with a second controller 414 of the power generator 102 and/or the expansion battery 104. The first controller 412 can include a digital communicator 416 including one or more communication ports for forming data connection(s) to the various components of the system 400 (such as the power generator 102 and/or the expansion battery 104). The digital communicator 416 can connect over a local area network (LAN), a wide area network (WAN) (such as the Internet), one or more application programming interface (API) connections or other communication protocols. The digital communicator 416 can provide various other types of connections, such as for a Universal Serial Bus (USB), Ethernet, Wi-Fi, Bluetooth®, Near Field Communication (NFC), a cellular network (such as a Third Generation Partnership Program (3GPP) network), and the like. Further, the digital communicator 416 may communicate with and/or include an antenna or other link for electromagnetic signal transmission and/or reception.

In some examples, the conversion cap 106 can determine that the multi-functional power distribution unit 108 is in the first configuration. For instance, the first controller 412 can receive an input voltage associated with the power received by the AC voltage connector 408. The one or more light indicator(s) 418 can receive an input voltage (such as from the second power connector) responsive to a determination that the multi-functional power distribution unit 108 is in the first configuration (such as connected to the power generator 102 via the voltage connector 408 and the first controller 412). As such, the light indicator(s) 418 can illuminate (such as a red light emitting diode (LED)) to indicate the multi-functional power distribution unit 108 is in the first configuration. Additionally or alternatively, the indicator(s) 418 can illuminate responsive to being in the second configuration (such as a blue, white, or green LED) to indicate that the AC power supply is available at the one or more power outlets 136. Moreover, the first controller 412 can send a control voltage signal to actuate one or more switch(es) 420 (such as cut-off switches) between the expansion battery 104 and the one or more power outlets 136, and/or between one or more inverter(s) 422 between the power connectors 404/406 and the one or more power outlets 136. As such, responsive to detecting that the multi-functional power distribution unit 108 is electrically coupled to the power generator 102 (such as in the first configuration), the conversion cap 106 can restrict power supply access to the one or more power outlets 136, effectively disabling the one or more power outlets 136. The indicator(s) 418 can indicate that the power outlets 136 are disabled or inactive and/or that the multi-functional power distribution unit 108 is in a state of operating to expand the output capacity of the power generator 102 (such as to between 2500 Wh and 3000 Wh). Additionally or alternatively, the light indicator(s) 418 can indicate that the expansion battery 104 is charging, or present other data representing a detected power voltage and/or capacity of the power generator 102.

In some examples, the second controller 414 of the power generator 102 can detect that the power generator 102 and the multi-functional power distribution unit 108 are in the first configuration. Responsive to this determination, the second controller 414 of the power generator 102 can perform one or more operating functions 424. For instance, the power generator 102 can have an increased output capacity for any power recipients connected to the power generator 102. The power generator 102 can also present at the display 122 an indication of the increased output capacity. The one or more operating functions 424 can include detecting a battery capacity of the expansion battery 104 and, if the battery capacity is above or meets a predetermined threshold, receive power from the expansion battery 104 (such as via the power connector 410). If the second controller 414 of the power generator 102 determines the battery capacity of the expansion battery 104 is below or does not meet a predetermined threshold, the power generator 102 can cause the power connector 410 to send an output voltage to the conversion cap 106. The output voltage can depend on a battery type and/or capacity for an optimal charge rate associated with that expansion battery 104. Additionally, responsive to detecting the connection to the conversion cap 106, the power generator 102 can send one or more messages to the first controller 412 providing information to the conversion cap 106 (such as a current output capacity, usage data, operational data, manufacturer/model information, and so forth).

In some instances, the conversion cap 106 includes a charger 426 (such as electromagnetic induction-based battery charger) for providing a charging voltage to the expansion battery 104, for instance, through the first terminal 112 and/or the second terminal 114. The conversion cap 106 can charge the expansion battery 104 responsive to receiving a threshold amount of power from the power generator 102. Additionally or alternatively, the conversion cap 106 can charge the expansion battery 104 responsive to plugging the voltage connector 408 into another power source (such as a wall outlet). In this case, the conversion cap 106 may also operate as a standalone power source (such as providing 120 AC V to the one or more power outlets 136) simultaneously with receiving wall outlet power and charging the expansion battery 104.

In some scenarios, the conversion cap 106 includes the first controller 412, which can be a computer or components of a computer integrated into, housed in, or otherwise communicatively coupled to the conversion cap 106. The first controller 412 can include one or more computing units which may implement the systems and methods discussed herein.

In some examples, data and program files may be input to the power connector 410, which reads the files and executes the programs therein. The first controller 412 can include one or more hardware processors, one or more data storage devices, one or more I/O ports, and/or one or more communication ports. Various elements of the first controller 412 may communicate with one another and with the other hardware and software components of the conversion cap 106, the expansion battery 104, and/or the power generator 102 by way of one or more communication buses, printed circuit board (PCB) pathways, wireless connections, point-to-point communication paths, or other communication means.

In some instances, the first controller 412 may be a microcontroller, a controller, a computer, a desktop computer, a laptop computer, a cellular or mobile device, a smart mobile device, a wearable device (such as a smart watch, smart glasses, a smart epidermal device, etc.) an Internet-of-Things (IoT) device, a smart home device, a virtual reality (VR) or augmented reality (AR) device, combinations thereof, and the like. The first controller 412 can provide operational control over the conversion cap 106. For instance, the first controller 412 can actuate the switch(es) 420, provide power to the indicator(s) 418, cause voltage changes for charging the expansion battery 104, and/or cause power to be provided to the one or more power outlets 136, and other operations discussed herein.

Operational components of the presently described technology are optionally implemented in software stored on the data storage device(s) and/or communicated via the one or more of the I/O port(s) and/or communication port(s), thereby transforming the first controller 412, as well as the conversion cap 106, into a special purpose machine for implementing the system 400.

The processor may include, for example, a central processing unit (CPU), a microprocessor, a microcontroller, a digital signal processor (DSP), and/or one or more internal levels of cache. There may be one or more processors, such that the processor comprises a single central-processing unit, or a plurality of processing units capable of executing instructions and performing operations in parallel with each other, commonly referred to as a parallel processing environment. Processing can be performed by the processor(s) locally, remotely, or combinations thereof.

The one or more data storage device(s) may include any non-volatile data storage device capable of storing data generated or employed within the first controller 412, such as computer-executable instructions for performing a computer process, which may include instructions of both application programs and an operating system (OS) that manages the various components of the first controller 412. The data storage device(s) may include, without limitation, magnetic disk drives, optical disk drives, solid state drives (SSDs), flash drives, and the like. The data storage devices may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The data storage device(s) may include volatile memory (such as dynamic random-access memory (DRAM), static random access memory (SRAM), etc.) and/or non-volatile memory (such as read-only memory (ROM), flash memory, etc.). The data storage device may include a non-transitory machine-readable medium having stored thereon instructions, which may be used to program a computer system (or other electronic devices) to perform a process according to the present inventive concept. A machine-readable medium includes any mechanism for storing information in a form (such as software, processing application) readable by a machine (such as a computer). The machine-readable medium may include, but is not limited to, magnetic storage medium, optical storage medium; magneto-optical storage medium, read only memory (ROM); random access memory (RAM); erasable programmable memory (such as EPROM and EEPROM); flash memory; or other types of medium suitable for storing electronic instructions.

Computer program products containing mechanisms to effectuate the systems and methods in accordance with the presently described technology may reside in the data storage device(s), which may be referred to as machine-readable media. It will be appreciated that machine-readable media may include any tangible non-transitory medium that is capable of storing or encoding instructions to perform any one or more of the operations of the present inventive concept for execution by a machine or that is capable of storing or encoding data structures and/or modules utilized by or associated with such instructions. Machine-readable media may include a single medium or multiple media (such as a centralized or distributed database, and/or associated caches and servers) that store the one or more executable instructions or data structures. The machine-readable media may store instructions that, when executed by the processor, cause the systems to perform the operations disclosed herein.

In some implementations, the first controller 412 includes one or more ports, such as the one or more input/output (I/O) port(s) and the one or more communication port(s), for communicating with other computing devices and/or the different assembly components discussed herein. It will be appreciated that the I/O port(s) and the communication port(s) may be combined or separate and that more or fewer ports may be included in the first controller 412.

For instance, the storage device of the first controller 412 can transmit data to an application on a mobile phone (such as one associated with a user of the conversion cap 106) to show an updated power capacity of the expansion battery 104, an output voltage capacity of the conversion cap 106 and/or the power generator 102, and/or combinations thereof. In some instances, usage data transmitted from the first controller 412 is collected at a remote server, which can perform data analytics to determine and/or cause an output presentation of usage behavior, daily usage patterns, historical power capacities, a current power capacity, and so forth.

In one implementation, the input devices convert a human-generated signal, such as, human voice, physical movement, physical touch or pressure, and/or the like, into electrical signals as input data into the first controller 412 via the I/O port. Similarly, the output devices may convert electrical signals received from first controller 412 via the I/O port into signals that may be sensed as output by a human, such as sound, light, and/or touch. The input device may be an alphanumeric input device, including alphanumeric and other keys for communicating information and/or command selections to the processor via the I/O port. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”) with a graphical user interface (GUI). The output devices may include, without limitation, a display, a touchscreen, a projector, a speaker, a tactile and/or haptic output device, and/or the like. In some implementations, the input device and the output device may be the same device, for example, in the case of a touchscreen.

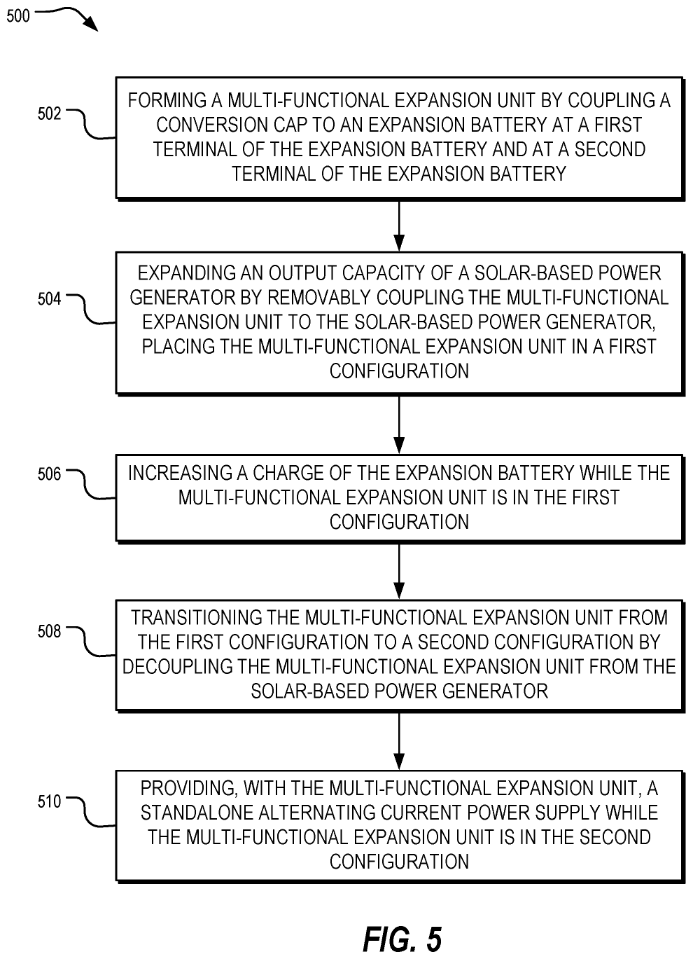

In an example implementation, operations performed by the systems discussed herein may be embodied by instructions stored on the data storage devices and executed by the processor. For instance, one or more operations of the methods disclosed herein, such as method 500 depicted in FIG. 5 and throughout this disclosure, may be implemented as sets of instructions or software readable by the first controller 412. Moreover, the expansion battery 104 and/or the power generator 102 can also include a controller (such as the second controller 414) having any or all of the features discussed herein regarding the first controller 412 of the conversion cap 106 and/or different combinations of controller features.

FIG. 5 illustrates an example method 500 for generating and/or distributing power. The method 500 can be performed by any of the systems 100-400 disclosed herein.

In some examples, at operation 502, the method 500 forms a multi-functional power distribution unit by coupling a conversion cap to an expansion battery at a first terminal of the expansion battery and at a second terminal of the expansion battery. At operation 504, the method 500 can expand an output capacity of a solar-based power generator by removably coupling the multi-functional power distribution unit to the solar-based power generator, placing the multi-functional power distribution unit in a first configuration. At operation 506, the method 500 can increase a charge of the expansion battery while the multi-functional power distribution unit is in the first configuration. At operation 508, the method 500 can transition the multi-functional power distribution unit from the first configuration to a second configuration by decoupling the multi-functional power distribution unit from the solar-based power generator. At operation 510, the method 500 can provide, with the multi-functional power distribution unit, a standalone alternating current power supply while the multi-functional power distribution unit is in the second configuration.

It is to be understood that the specific order or hierarchy of steps in the method(s) 500 depicted in FIG. 5 and throughout this disclosure are instances of example approaches and can be rearranged while remaining within the disclosed subject matter. For instance, any of the operations depicted in FIG. 5 and throughout this disclosure may be omitted, repeated, performed in parallel, performed in a different order, and/or combined with any other of the operations depicted in FIG. 5 and throughout this disclosure.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A power distribution system including:
a conversion cap, which removably couples to a top surface of an expansion battery, forming a multi-functional power distribution unit transitionable between:
a first configuration in which the multi-functional power distribution unit is removably coupled to a solar-based power generator to:
expand an output capacity of the solar-based power generator, and
charge the expansion battery; and
a second configuration in which the multi-functional power distribution unit operates as a standalone alternating current power supply.

2. The power distribution system of claim 1, wherein:
the top surface of the expansion battery includes:
a first terminal;
a second terminal; and
an indent; and
the conversion cap includes:
a first spring-loaded power connector extending from a first corner of the conversion cap for coupling to the first terminal;
a second spring-loaded power connector extending from a second corner of the conversion cap for coupling to the second terminal; and
a connector protrusion for engaging the indent.

3. The power distribution system of claim 1, wherein:
the top surface of the expansion battery is raised above an outer shelf disposed around a perimeter of the expansion battery; and
the expansion battery further includes:
one or more handles slidable into a position resting on the outer shelf of the expansion battery.

4. The power distribution system of claim 3, wherein:
the one or more handles are rotatable, from the s the outer shelf, over a central elevated top surface of the conversion cap; and
one or more gripping gaps are formed between the one or more handles and one or more lower tier surfaces of the conversion cap adjacent to the central elevated top surface.

5. The power distribution system of claim 1, wherein, the expansion battery includes a 12 volt lithium battery.

6. The power distribution system of claim 1, wherein the multi-functional power distribution unit forms a portable power supply in the second configuration, and the solar-based power generator is a portable power generator.

7. A power distribution system including:
an expansion battery with a top surface including a first terminal and a second terminal; and
a conversion cap, which removably couples to the expansion battery, forming a multi-functional power distribution unit transitionable between:
a first configuration expanding an output capacity of a solar-based power generator, and
a second configuration as a standalone alternating current power supply.

8. The power distribution system of claim 7, wherein the conversion cap has a footprint corresponding to the top surface of the expansion battery such that a conversion cap perimeter is within an expansion battery perimeter when the conversion cap is coupled to the expansion battery.

9. The power distribution system of claim 7, wherein the conversion cap includes:
a charger, communicatively coupled to the expansion battery, and providing an input voltage, received from the solar-based power generator, to the expansion battery;
a regulator for regulating output voltages of the conversion cap;
one or more power outlets on a front face of the conversion cap; and
a power inverter to provide the standalone alternating current power supply, from the expansion battery, through the one or more power outlets.

10. The power distribution system of claim 9, wherein the input voltage is received from the solar-based power generator through a power cord of the conversion cap, the power cord plugging into the solar-based power generator.

11. The power distribution system of claim 9, wherein the one or more power outlets are within an expansion battery perimeter when the multi-functional power distribution unit is in the second configuration.

12. The power distribution system of claim 9, wherein the conversion cap includes a controller which:
receives an indication that the multi-functional power distribution unit is in the first configuration; and
actuates, in response to the indication that the multi-functional power distribution unit is in the first configuration, a cut-off switch causing power access to be restricted from the one or more power outlets.

13. The power distribution system of claim 12, wherein:
the conversion cap includes a light indicator; and
the controller, in response to actuating the cut-off switch, activates the light indicator visually representing the power access being restricted from the one or more power outlets.

14. The power distribution system of claim 7, wherein the conversion cap includes a digital communicator to send a communication, to a controller of the solar-based power generator, in response to the multi-functional power distribution unit transitioning to the first configuration.

15. The power distribution system of claim 14, wherein the solar-based power generator performs an operation in response to receiving the communication from the conversion cap.

16. The power distribution system of claim 7, wherein the conversion cap uses a three-point coupling arrangement to removably couple to a top surface of the expansion battery.

17. The power distribution system of claim 16, wherein the three-point coupling arrangement includes:
a first spring-loaded power connector extending from a first corner of the conversion cap for coupling to the first terminal of the expansion battery;
a second spring-loaded power connector extending from a second corner of the conversion cap for coupling to the second terminal of the expansion battery; and
a connector protrusion for engaging a corresponding indent in a top surface of the expansion battery.

18. The power distribution system of claim 7, wherein the multi-functional power distribution unit:
includes one or more power cord; and
is chargeable:
in the first configuration by receiving power through the one or more power cord connected to the solar-based power generator while simultaneously expanding the output capacity of the solar-based power generator; and
in a third configuration by receiving power through the one or more power cord connected to an alternating current wall outlet.

19. A method of generating solar-based power, the method including:
forming a multi-functional power distribution unit by coupling a conversion cap to an expansion battery at a first terminal of the expansion battery and at a second terminal of the expansion battery;
expanding, as a first configuration of the multi-functional power distribution unit, an output capacity of a solar-based power generator by a removable coupling of the multi-functional power distribution unit to the solar-based power generator;
increasing a charge of the expansion battery while the multi-functional power distribution unit is in the first configuration;
transitioning the multi-functional power distribution unit between the first configuration and a second configuration using the removable coupling; and
providing, with the multi-functional power distribution unit, a standalone alternating current power supply while the multi-functional power distribution unit is in the second configuration.

20. The method of claim 19, further comprising, in response to transitioning the multi-functional power distribution unit from the first configuration to a second configuration, actuating a switch in the multi-functional power distribution unit to provide power from the expansion battery, through an inverter, to one or more outlets disposed on the conversion cap.
